(19) United States
(12) Patent Application Publication
(10) Pub. No.: US 2025/0364002 A1
(43) Pub. Date: Nov. 27, 2025

(54) ZERO SHOT BINAURAL AUDIO SYNTHESIS

(71) Applicant: Google LLC, Mountain View, CA (US)

(72) Inventors: Eliya Nachmani, Jerusalem (IL); Alon Levkovitch, Gibatayim (IL); Willem Bastiaan Kleijn, Eastbourne (NZ); Julian Emilio Sanchez Salazar, San Francisco, CA (US); Soroosh Mariooryad, Los Altos, CA (US); Russell John Wyatt Skerry-Ryan, Mountain View, CA (US); Nadav Bar, Raanana (IL)

(21) Appl. No.: 19/215,998

(22) Filed: May 22, 2025

Related U.S. Application Data
(60) Provisional application No. 63/650,840, filed on May 22, 2024.

(51) Int. Cl. G10L 19/16; G10L 19/008; G10L 25/30

(52) U.S. Cl. CPC G10L 19/16; G10L 19/008; G10L 25/30

(57) ABSTRACT

Systems, methods, and apparatus for generating binaural audio waveform from mono waveform data. In an aspect, operations include generating, based on a mono waveform data and positional data, left signal data and right signal data, wherein the left signal data and the right signal data are initial estimates of perceived signals of the mono waveform based on the positional data; processing the left signal data and right signal data, based on the positional data, to generate amplitude scaled left signal data and amplitude scaled right signal data; and separately processing the amplitude scaled left signal data and the amplitude scaled right signal data by a denoising vocoder to generate left output signal data and right output signal data that together define a binaural audio waveform based on the mono waveform data.

### CROSS-REFERENCE TO RELATED APPLICATION

This application claims the benefit of priority under 35 U.S.C. § 119(e) to U.S. Provisional Application No. 63/650,840, filed on May 22, 2024, the contents of which are hereby incorporated by reference.

### BACKGROUND

Humans possess a remarkable ability to localize sound sources and perceive the surrounding environment through auditory cues alone. This sensory ability, known as spatial hearing, plays a critical role in numerous everyday tasks, including identifying speakers in crowded conversations and navigating complex environments. Hence, emulating a coherent sense of space via listening devices like headphones becomes paramount to creating truly immersive artificial experiences. Due to the lack of multi-channel and positional data for most acoustic and room conditions, the robust and low/zero-resource synthesis of binaural audio from single-source, single-channel (mono) recordings is a crucial step towards advancing augmented reality (AR) and virtual reality (VR) technologies.

The task of synthesizing binaural audio from monophonic sources presents a significant challenge for supervised learning models, however. This difficulty stems from two primary limitations: (1) the scarcity of position-annotated binaural audio datasets, and (2) the inherent variability of real-world environments, characterized by diverse room acoustics and background noise conditions. Data collection for supervised learning necessitates specialized equipment, including tracking systems and binaural recording devices, which are both cost-prohibitive and often unavailable. Moreover, supervised models are susceptible to overfitting on the specific rooms, speaker characteristics, and languages in the training data, especially when the data are small.

### SUMMARY

This specification relates to model systems, and in particular, using a generative audio model for binaural synthesis.

In an implementation, a computer-implemented method comprises generating, based on a mono waveform data and positional data, left signal data and right signal data, wherein the left signal data and the right signal data are initial estimates of perceived signals of the mono waveform based on the positional data; processing the left signal data and right signal data, based on the positional data, to generate amplitude scaled left signal data and amplitude scaled right signal data; and separately processing the amplitude scaled left signal data and the amplitude scaled right signal data by a denoising vocoder to generate left output signal data and right output signal data that together define a binaural audio waveform based on the mono waveform data.

In an implementation in combination with the above, separately processing the amplitude scaled left signal data and the amplitude scaled right signal data by a denoising vocoder to generate left output signal data and right output signal data comprises: generating, for the left signal data, a temporal sequence conditioning vector c^{l}; iteratively denoising the left signal data based on the conditioning vector c^{l} and a noise level k; generating, for the right signal data, a temporal sequence conditioning vector c″; iteratively denoising the right signal data based on the conditioning vector c^{r} and a noise level k.

In an implementation in combination with any of the above, generating, for the left signal data, the temporal sequence conditioning vector c^{l} comprises generating the temporal sequence conditioning vector c^{l} by extracting log-mel features of the left signal data; and generating, for the right signal data, the temporal sequence of conditioning vector c^{r} comprises generating the temporal sequence conditioning vector c^{r} by extracting log-mel features of the left signal data.

In an implementation in combination with the above, the operations further comprise training the denoising vocoder with a starting noise of ŷ_{K}˜ [symbol] (0, Σ_{c}) where Σ_{c} is a covariance matrix based on a spectrogram c.

In an implementation in combination with the above, the denoising vocoder is a neural vocoder that takes a denoising perspective of a denoising diffusion probabilistic model and a discriminator to learn a sample-free iterable map that generates natural speech from a degraded input speech signal.

In an implementation with any of the above, generating the binaural audio waveform from the mono waveform data is done without training on binaural data.

In an implementation in combination with the above, processing the left signal data and right signal data, based on the positional data, to generate amplitude scaled left signal data and amplitude scaled right signal data comprises scaling the amplitudes of the left signal data and the right signal data based on distance data defined by a source location, a right side receiving location, and a left side receiving location defined by the positional data.

According to a further aspect, there is provided a system comprising one or more computers and one or more storage devices storing instructions that are operable, when executed by one or more computers, to cause the one or more computers to perform any of the operations of the method described above. According to another aspect, there is provided a computer storage medium encoded with instructions that, when executed by one or more computers, cause the one or more computers to perform any of the operations of the method described above.

The above implementations may realize one or more of the following advantages. The systems and methods can synthesize binaural audio from monaural audio recordings and positional information without training on any binaural data. This reduces data training requirements and simplifies the generation process. The zero-shot processes described below for mono-to-binaural audio synthesis utilizes parameter-free geometric time warping and amplitude scaling based on positional data of the monaural data. This suffices to obtain an initial binaural synthesis that can be refined by iteratively applying a pre-trained denoising vocoder. The denoising vocoder processes each channel of the initial binaural synthesis independently. That is, the vocoder can be a monoaural vocoder trained on monoaural data only. The zero-shot method is perceptually on par with the performance of supervised methods on standard mono-to-binaural dataset, and thus realizes equal performance while reducing the training and processing requirements, resulting in computer resource savings.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of zero shot mono to binaural synthesis system.

FIG. 2 is a block diagram of an example implementation of the zero-shot mono to binaural synthesis system.

FIG. 3 is a flow diagram of an example process of zero shot mono to binaural synthesis.

Like reference numbers and designations in the various drawings indicate like elements.

### DETAILED DESCRIPTION

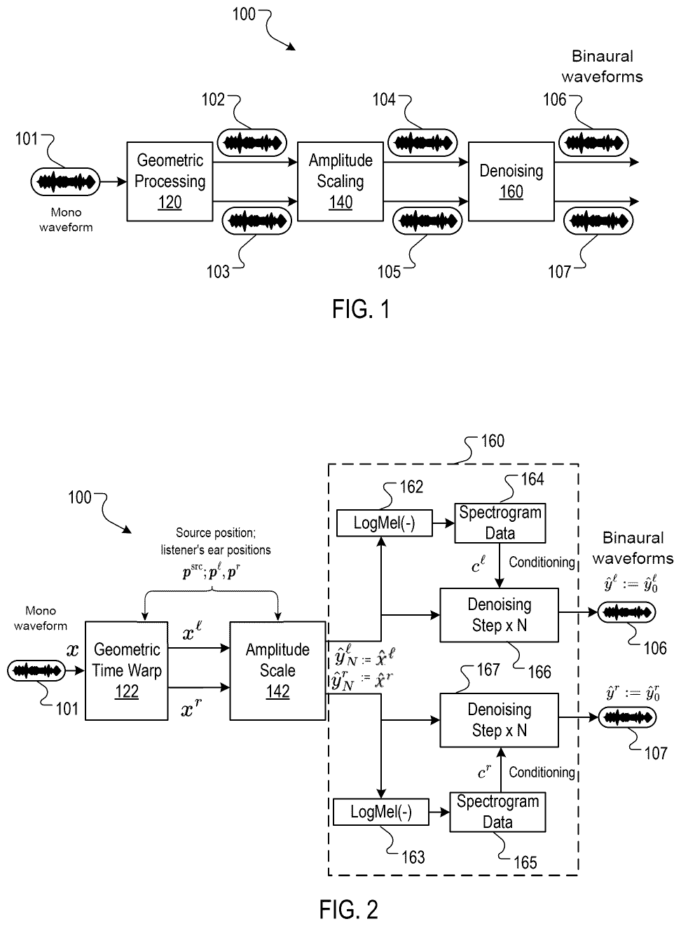

FIG. 1 is a block diagram of a zero shot mono to binaural synthesis system 100. The system 100 utilizes a three-stage architecture comprising a geometric processing stage 120, an amplitude scaling stage 140, and a denoising stage 160.

The geometric processing stage 120 manipulates the input mono waveform 101 into two channels of left signal data 102 and right signal data 103 based on position information. For example, the geometric processing stage 120 can be configured to apply an interaural time delay based upon provided position information. The position information can include positional data based upon a listener's left and right ear locations and/or a location of or distance to sound sources for example. The amplitude scaling stage 140 adjusts the amplitude of the left signal data 102 and right signal data 103 based on an acoustic model framework to generate amplitude scaled left signal data 104 and amplitude scaled right signal data 105. For example, the amplitude scaling stage 140 can be configured to apply an interaural level difference based upon the position information. Finally, the denoising stage 160 eliminates or reduces acoustic artifacts and/or inconsistencies in the amplitude scaled left signal data 104 and amplitude scaled right signal data 105 to generate left output signal data 106 and right output signal data 107 that together define a binaural audio waveform based on the mono waveform 101.

Any appropriate sub-process can be used for each of the geometric processing stage 120, amplitude scaling stage 140, and denoising stage 160. FIG. 2 is a block diagram of an example implementation of the zero-shot mono to binaural synthesis system 100.

In the example implementation of FIG. 2, the geometric processing stage 120 is a geometric time warp (GTW) stage 122. The GTW stage 122 can apply an interaural time delay. The GTW stage 122 manipulates the input mono waveform 101 into two channels based on the provided position information. For example, assume x denotes the mono source signal input waveform data 101. A position of the source of x at time t is given by the 3D vector

$${p}_{t}^{src} .$$

The values [symbol] and r correspond to the listener's left and right ear. Their positions at t are given by 3D vectors

$${p}_{t}^{ℓ} , {p}_{t}^{r} .$$

The system 100 first applies GTW via the GTW stage 122 to x conditioned on

$${p}_{t}^{src} , {p}_{t}^{ℓ} and {p}_{t}^{r} .$$

The warping processing generates left and right preprocessed channels, denoted by [symbol] and x^{r}, which are left signal data 102 and right signal data 103, respectively. The GTW stage 122 can be parameter-free, that is, this stage does not require training.

In the implementation of FIG. 2, a Euclidean amplitude scaling stage 142 is employed jointly on [symbol] and x^{r}, conditioning on the same positioning data

$${p}_{t}^{src} , {p}_{t}^{ℓ} and {p}_{t}^{r} .$$

The amplitude scaling stage 142 further enhances the spatial perception of the signal, generating intermediate left and right channels are denoted by [symbol] and \hat{x}^{r}, respectively, which are the amplitude scaled left signal data and amplitude scaled right signal data, respectively. The amplitude scaling stage 142 can apply an interaural level difference. The amplitude scaling stage 142 can be parameter-free.

Finally, in FIG. 2, a denoising vocoder 160 iteratively refines the processed signal to generate the binaural output composed of two channels. In general, a denoising vocoder iteratively removes or estimates the noise to remove from a noisy audio signal. In the implementation of FIG. 2, the denoising vocoder 160 sets its noisy inputs

$${\hat{y}}_{N}^{ℓ} , {\hat{y}}_{N}^{r}$$

to be the outputs of the scaling stage 142, [symbol] , \hat{x}^{r}. The inputs

$${\hat{y}}_{N}^{ℓ} , {\hat{y}}_{N}^{r}$$

are fed separately into a pretrained denoising vocoder, which treats each waveform

$${\hat{y}}_{N}^{ℓ} , {\hat{y}}_{N}^{r}$$

as mono audio. One example denoising vocoder is a WaveFit neural vocoder as described by WaveFit Koizumi et. al, WaveFit: an Iterative and non-autoregressive neural vocoder based on fixed-point iteration, https://arxiv.org/pdf/2210.01029, the disclosure of which is incorporated herein by reference. This particular pretrained denoising vocoder comprises a conditioning input of temporal sequences of conditioning vectors c^{l}, c^{r} which are obtained by extracting the log-mel features of [symbol] ,\hat{x}^{r}. In some implementations, a low noise level k can also be used for conditioning to reflect emulating an input that is “close” to a true binaural sample. For the WaveFit denoising vocoder, the noise level k is given by a choice of a conditioning timestep, i.e., the last timestep of the WaveFit training denoising process. This sampling is repeated for N iterations. As the left and right signals are treated as mono audio at this stage, any mono denoising vocoder can be used. A denoising vocoder configured to process binaural audio data is not required and the denoising vocoder does not need to have been trained on binaural audio data. The denoising vocoder can be trained on mono audio data only. Given the abundance of mono audio training data (as compared to binaural audio training data), a high-performing mono denoising vocoder can be more easily trained. The denoising vocoder can be based upon a denoising diffusion probabilistic model (DDPM).

Further exemplary details are provided for each stage below.

### Geometric Time Warping Stage 122

The GTW stage 122 estimates a warpfield that separates the left and right binaural signals by applying the interaural time delay (ITD) based on the relative positions of the sound source and the listener's ears. This generates an initial estimate of the perceived signals. This approach I implements a lightweight and parameter-free solution for a warpfield that can be applied to the mono signal. Let S denote the signal's sample rate and v_{sound} represent the speed of sound. GTW stage 122 accomplishes warping by computing a warpfield for both the left and right listening channels, denoted by [symbol] (t), ρ^{r}(t) below. The values of this warpfield are computed using the source position and listener ear positions

$${p}_{t}^{src} , {p}_{t}^{ℓ} , {p}_{t}^{r} :$$

$$\begin{matrix}{ρ}^{ℓ} ( t ) := t - \frac{S}{{v}_{sound}} {‖ {p}_{t}^{s c} - {p}_{t}^{ℓ} ‖}_{2} , \\ {ρ}^{r} ( t ) := t - \frac{s}{{v}_{sound}} {‖ {p}_{t}^{s c} - {p}_{t}^{r} ‖}_{2}\end{matrix}$$

In some implementations, to generate integer values from this function, the GTW stage 122 can define the warped left and right signals [symbol] , \hat{x}^{r} with respect to the original indexing t via linear interpolation:

$$\begin{matrix}{x}_{t}^{ℓ} := ( ⌈ {ρ}^{ℓ} ( t ) ⌉ - {ρ}^{ℓ} ( t ) ) \cdot {x}_{⌊ {ρ}^{ℓ} ( t ) ⌋} + ( {ρ}^{ℓ} ( t ) - ⌊ {ρ}^{ℓ} ( t ) ⌋ ) \cdot {x}_{⌈ {ρ}^{ℓ} ( t ) ⌉} , \\ {x}_{t}^{r} := ( ⌈ {ρ}^{r} ( t ) ⌉ - {ρ}^{r} ( t ) ) \cdot {x}_{⌊ {ρ}^{r} ( t ) ⌋} + ( {ρ}^{r} ( t ) - ⌊ {ρ}^{r} ( t ) ⌋ ) \cdot {x}_{⌈ {ρ}^{r} ( t ) ⌉} .\end{matrix}$$

### Amplitude Scaling Stage 142

In addition to manipulating the time-delay of the signal by the GTW stage 122, the system 100 includes the amplitude scaling stage 142 to manipulate the amplitude of the signal based on the position of the speaker. Human spatial perception of sound relies on various factors, including the ITD, the interaural level difference (ILD), and spectral cues due to head related transfer function (HRTFs). A variety of amplitude scaling processes can be used, such as modelling ILD by a scattering model of scattering off of the head, particularly with weighting spatial perception for sounds with high frequencies.

In another implementation, the scaling is based on the inverse square law. This modeling also has a positive effect on the perceived spatial accuracy of the processed signal. The scaling stage 142 leverage the inverse square amplitude manipulation to enhance the spatial realism of the generated binaural audio. Let D be the Euclidean distance from the origin of the sound waves. Then by the inverse-square law, pressure drops at a

$$\frac{1}{{D}^{2}}$$

ratio. In the case of microphones, pressure manifests as amplitude. Using left-right microphone distance as an approximation of human heads, the scaling stage 142 defines the following left and right distances,

$${D}_{t}^{ℓ} and {D}_{t}^{r} :$$

$$\begin{matrix}{D}_{t}^{ℓ} = {‖ {p}^{src} - {p}_{t}^{ℓ} ‖}_{2} , \\ {D}_{t}^{r} = {‖ {p}^{s c c} - {p}_{t}^{r} ‖}_{2}\end{matrix}$$

At t each time step, the scaling stage 142 scale down the magnitude of the side furthest from the source, using the ratio of the closer side's distance versus the further side's distance, according to the following condition:

$$\begin{matrix}{\hat{x}}_{t}^{ℓ} := min ( 1 , {( \frac{{D}_{t}^{r}}{{D}_{t}^{ℓ}} )}^{2} ) \cdot {x}_{t}^{ℓ} , \\ {\hat{x}}_{t}^{r} := min ( 1 , {( \frac{{D}_{t}^{ℓ}}{{D}_{t}^{r}} )}^{2} ) \cdot {x}_{t}^{r}\end{matrix}$$

### Denoising Vocoder

The GTW stage 122 and the amplitude scaling stage 142 are lightweight, parameter-free operations that roughly approximates binaural audio. The warped and scaled speech signals [symbol] , \hat{x}^{r} resulting from these two stages can have acoustic artifacts and inconsistencies. Accordingly, the denoising vocoder stage 160 is used to further refine the left and right signal data to generate natural-sounding binaural audio. In the implementation of FIG. 2, the denoising vocoder stage 160 uses a denoising vocoder on each of the left and right signal data independently. As noted above, the WaveFit neural vocoder can be used, but other denoising vocoders can also be used. This is a fixed-point iteration vocoder that takes the denoising perspective of denoising diffusion probabilistic models (DDPMS)s, and takes the discriminator of generative adversarial networks, such a MelGAN (a non-autoregressive feed-forward convolutional architecture that perform audio waveform generation in a generative adversarial network (GAN)) to learn a sampling-free iterable map that can generate natural speech from a degraded input speech signal. The sampling-free iterable map involves applying a fixed diffusion function on initial noise iterably to converge to a spectrogram. Because the function is fixed, the process is deterministic.

In an implementation, the denoising vocoder takes log-mel spectrogram features and noise as input and produces clean waveform output. For example, a LogMel processes a 162 and 163 are performed on the waveform data

$${\hat{y}}_{N}^{ℓ} , {\hat{y}}_{N}^{r} ,$$

respectively, to generate respective sepectrogram data 164 and 165, which are then represented as conditioning vectors c^{l}, c^{r}. More succinctly, for each left and right channel, the follower iterative operation is performed:

$${\hat{y}}_{i - 1} := {𝒱}_{θ} ( {\hat{y}}_{i} , c , k ) := ( {\hat{y}}_{i} - {θ}_{} ( {\hat{y}}_{i} , c , k ) , c ) ,$$

In the iterative operation above, c is the spectrogram data, and ŷᵢ₋₁ is a candidate waveform refined from ŷᵢ. [symbol] is a parameter-free gain adjustment operator and [symbol] _{θ} is an architecture trained for reconstruction under a discriminator, such as described in Chen et. al., WaveGrad: Estimating gradients for waveform generation, https://arxiv.org/pdf/2009.00713, the disclosure of which is incorporated herein by reference.

At training time, a starting noise is given by ŷ_{K}˜ [symbol] (0, Σ_{c}) where Σ_{c} is a covariance matrix initialized to capture the spectral envelope of c; both k, i iterate over K, . . . ,1. Then, at inference time, the GTW stage 122 approximates by iterating at the noise level of WaveFit's final denoising step (k=1). The GTW 122 then iteratively denoises

$${\hat{y}}_{N}^{ℓ} , {\hat{y}}_{N}^{r} := {\hat{x}}^{ℓ} , {\hat{x}}^{r}$$

via the denoising steps 166 and 167, respectively, conditioning the signals on their respective initial log-mel spectrograms and the fixed low noise level for steps i=N, . . . , 1.

The example implementation of FIG. 2, as described above, implements the following example algorithm. Given a denoising vocoder V_{θ}, iteration count N, low noise level k, and the following temporal sequences: mono waveform x, speaker (or source) position

$${p}_{t}^{s r c} ,$$

and listener ear locations

$${p}_{t}^{ℓ} , {p}_{t}^{r} ,$$

the following processes are performed:

$$\begin{matrix}{\hat{x}}^{ℓ} , {\hat{x}}^{r} = GeometricTimeWarping ( x , {p}_{t}^{s r c} , {p}_{t}^{ℓ} , {p}_{t}^{r} ) \\ {\hat{x}}^{ℓ} , {\hat{x}}^{r} = AmplitudeScaling ( {\hat{x}}^{ℓ} , {\hat{x}}^{r} , {p}_{t}^{s r c} , {p}_{t}^{ℓ} , {p}_{t}^{r} ) \\ {c}^{l} , {c}^{r} = LogMel ( {\hat{x}}^{l} ) , LogMel ( {\hat{x}}^{r} ) \\ {\hat{y}}_{N}^{ℓ} , {\hat{y}}_{N}^{r} := {\hat{x}}^{ℓ} , {\hat{x}}^{r} \\ For i ← N to 1 do \\ {\hat{y}}_{i - 1}^{ℓ} := {𝒱}_{θ} ( {\hat{y}}_{i}^{l} , {c}^{l} , k ) , \\ {\hat{y}}_{i - 1}^{r} := ( {\hat{y}}_{i}^{r} , {c}^{r} , k ) \\ end for \\ return {\hat{y}}^{ℓ} , {\hat{y}}^{r} := {\hat{y}}_{0}^{ℓ} , {\hat{y}}_{0}^{r}\end{matrix}$$

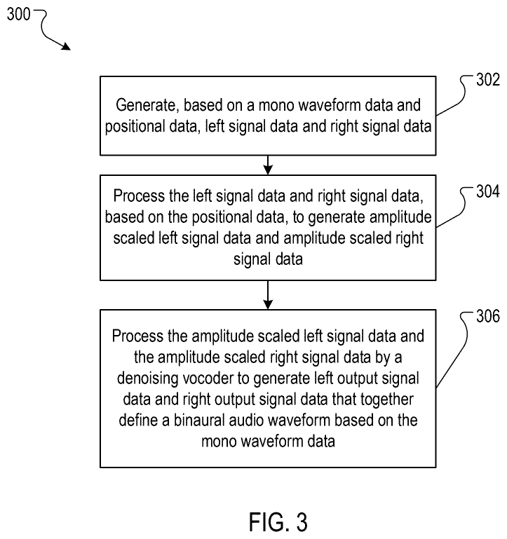

FIG. 3 is a flow diagram of an example process 300 of zero shot mono to binaural synthesis. The process 300 can be implemented in a data processing apparatus that includes one or more processors that executed instructions that cause the processors to perform the operations described for the process 300.

The process 300 generates, based on a mono waveform data and positional data, left signal data and right signal data (302). For example, the system 100 can process the mono waveform data 101 using the GTW stage 122 to generate the left signal data 102 and right signal data 103, as described above.

The process 300 processes the left signal data and right signal data, based on the positional data, to generate amplitude scaled left signal data and amplitude scaled right signal data (304). For example, the system 100 can process the left signal data 102 and right signal data 103 using the amplitude scaling stage 142 to generate the amplitude scaled left signal data 104 and amplitude scaled right signal data 105, as described above.

The process 300 processes the amplitude scaled left signal data and the amplitude scaled right signal data by a denoising vocoder to generate left output signal data and right output signal data that together define a binaural audio waveform based on the mono waveform data (306). For example, the system 100 can process the amplitude scaled left signal data 104 and amplitude scaled right signal data 105 by the denoising vocoder 162 to generate the left output signal data 106 and right output signal data 107 that together define a binaural audio waveform, as described above.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally, or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications and may be deployed in distributed or cloud-based environments where components reside on different machines or within a cloud infrastructure.

The term “computing device, “data processing apparatus,” or “hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively, or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for generating binaural audio waveform from mono waveform data, comprising:
generating, based on a mono waveform data and positional data, left signal data and right signal data, wherein the left signal data and the right signal data are initial estimates of perceived signals of the mono waveform based on the positional data;
processing the left signal data and right signal data, based on the positional data, to generate amplitude scaled left signal data and amplitude scaled right signal data; and
separately processing the amplitude scaled left signal data and the amplitude scaled right signal data by a denoising vocoder to generate left output signal data and right output signal data that together define a binaural audio waveform based on the mono waveform data.

2. The computer-implemented method of claim 1, wherein separately processing the amplitude scaled left signal data and the amplitude scaled right signal data by a denoising vocoder to generate left output signal data and right output signal data comprises:
generating, for the left signal data, a temporal sequence conditioning vector c^{l};
iteratively denoising the left signal data based on the conditioning vector c^{l} and a noise level k;
generating, for the right signal data, a temporal sequence conditioning vector c^{r};
iteratively denoising the right signal data based on the conditioning vector c^{r} and a noise level k.

3. The computer-implemented method of claim 2, wherein:
generating, for the left signal data, the temporal sequence conditioning vector c^{l} comprises generating the temporal sequence conditioning vector c^{l} by extracting log-mel features of the left signal data; and
generating, for the right signal data, the temporal sequence of conditioning vector c^{r} comprises generating the temporal sequence conditioning vector c^{r} by extracting log-mel features of the left signal data.

4. The computer implemented method of claim 3, further comprising training the denoising vocoder with a starting noise of ŷ_{K}˜ [symbol] (0, Σ_{c}) where Σ_{c} is a covariance matrix based on a spectrogram c.

5. The computer-implemented method of claim 4, wherein the denoising vocoder is a neural vocoder that takes a denoising perspective of a denoising diffusion probabilistic model and a discriminator to learn a sample-free iterable map that generates natural speech from a degraded input speech signal.

6. The computer-implemented method of claim 1, wherein generating the binaural audio waveform from the mono waveform data is done without training on binaural data.

7. The computer-implemented method of claim 1, wherein processing the left signal data and right signal data, based on the positional data to generate amplitude scaled left signal data and amplitude scaled right signal data comprises scaling the amplitudes of the left signal data and the right signal data based on distance data defined by a source location, a right side receiving location, and a left side receiving location defined by the positional data.

8. A system comprising one or more computers and one or more storage devices storing instructions that are operable, when executed by the one or more computers, to cause the one or more computers to perform the operations comprising:
generating, based on a mono waveform data and positional data, left signal data and right signal data, wherein the left signal data and the right signal data are initial estimates of perceived signals of the mono waveform based on the positional data;
processing the left signal data and right signal data, based on the positional data, to generate amplitude scaled left signal data and amplitude scaled right signal data; and
separately processing the amplitude scaled left signal data and the amplitude scaled right signal data by a denoising vocoder to generate left output signal data and right output signal data that together define a binaural audio waveform based on the mono waveform data.

9. The system of claim 8, wherein separately processing the amplitude scaled left signal data and the amplitude scaled right signal data by a denoising vocoder to generate left output signal data and right output signal data comprises:
generating, for the left signal data, a temporal sequence conditioning vector c^{l};
iteratively denoising the left signal data based on the conditioning vector c^{l} and a noise level k;
generating, for the right signal data, a temporal sequence conditioning vector c^{r};
iteratively denoising the right signal data based on the conditioning vector c^{r} and a noise level k.

10. The system of claim 9, wherein:
generating, for the left signal data, the temporal sequence conditioning vector c^{l} comprises generating the temporal sequence conditioning vector c^{l} by extracting log-mel features of the left signal data; and
generating, for the right signal data, the temporal sequence of conditioning vector c^{r} comprises generating the temporal sequence conditioning vector c^{r} by extracting log-mel features of the left signal data.

11. The system of claim 10, further comprising training the denoising vocoder with a starting noise of ŷ_{K}˜ [symbol] (0, Σ_{c}) where Σ_{c} is a covariance matrix based on a spectrogram c.

12. The system of claim 11, wherein the denoising vocoder is a neural vocoder that takes a denoising perspective of a denoising diffusion probabilistic model and a discriminator to learn a sample-free iterable map that generates natural speech from a degraded input speech signal.

13. The system of claim 12, wherein generating the binaural audio waveform from the mono waveform data is done without training on binaural data.

14. The system of claim 13, wherein processing the left signal data and right signal data, based on the positional data, to generate amplitude scaled left signal data and amplitude scaled right signal data comprises scaling the amplitudes of the left signal data and the right signal data based on distance data defined by a source location, a right side receiving location, and a left side receiving location defined by the positional data.

15. A computer storage medium encoded with instructions that, when executed by one or more computers, cause the one or more computers to perform the operations comprising:
generating, based on a mono waveform data and positional data, left signal data and right signal data, wherein the left signal data and the right signal data are initial estimates of perceived signals of the mono waveform based on the positional data;
processing the left signal data and right signal data, based on the positional data, to generate amplitude scaled left signal data and amplitude scaled right signal data; and
separately processing the amplitude scaled left signal data and the amplitude scaled right signal data by a denoising vocoder to generate left output signal data and right output signal data that together define a binaural audio waveform based on the mono waveform data.

16. The computer storage medium of claim 15, wherein separately processing the amplitude scaled left signal data and the amplitude scaled right signal data by a denoising vocoder to generate left output signal data and right output signal data comprises:
generating, for the left signal data, a temporal sequence conditioning vector c^{l};
iteratively denoising the left signal data based on the conditioning vector c^{l} and a noise level k;
generating, for the right signal data, a temporal sequence conditioning vector c^{r};
iteratively denoising the right signal data based on the conditioning vector c^{r} and a noise level k.

17. The computer storage medium of claim 16, wherein:
generating, for the left signal data, the temporal sequence conditioning vector c^{l} comprises generating the temporal sequence conditioning vector c^{l} by extracting log-mel features of the left signal data; and
generating, for the right signal data, the temporal sequence of conditioning vector c^{r} comprises generating the temporal sequence conditioning vector c^{r} by extracting log-mel features of the left signal data.

18. The computer storage medium of claim 17, wherein the operations further comprise training the denoising vocoder with a starting noise of ŷ_{K}˜ [symbol] (0, Σ_{c}) where Σ_{c} is a covariance matrix based on a spectrogram c.

19. The computer storage medium of claim 17, wherein the denoising vocoder is a neural vocoder that takes a denoising perspective of a denoising diffusion probabilistic model and a discriminator to learn a sample-free iterable map that generates natural speech from a degraded input speech signal.

20. The computer storage medium of claim 15, wherein generating the binaural audio waveform from the mono waveform data is done without training on binaural data.
